(19) United States
(12) Patent Application Publication
(10) Pub. No.: US 2005/0042769 A1
(43) Pub. Date: Feb. 24, 2005

(54) Biomolecule handling method and machine using an array dispenser

(75) Inventors: Thomas Laurell, Lund (SE); Johan Nilsson, Bjarred (SE); Gyorgy Marko-Varga, Malmo (SE)

Correspondence Address: LADAS & PARRY LLP, 224 SOUTH MICHIGAN AVENUE, SUITE 1200, CHICAGO, IL, 60604, US

(73) Assignee: Astrazeneca AB, 151 85 Sodertalje (SE)

(21) Appl. No.: 10/497,992

(22) PCT Filed: Dec. 11, 2002
(86) PCT No.: PCT/SE02/02279

(30) Foreign Application Priority Data
Dec. 11, 2001 (SE) 0104125-0
Jul. 15, 2002 (SE) 0202227-5
Aug. 13, 2002 (SE) 0202401-6

(51) Int. Cl. G01N 1/10

(52) U.S. Cl. 436/180; 422/100

(57) ABSTRACT

The invention relates to a method and a machine for biomolecule handling using an array dispenser. More particularly, the invention relates to a method and a machine in which one or two separation procedures are performed in parallel channels and the separated biomolecules are deposited on a two-dimensional target plate for analysis e.g. in a MALDI TOF MS device (Matrix Assisted Laser Desorption/Ionisation Time-of-Flight Mass Spectrometry). A method of sample handling comprises the following steps: supplying (101) a number of samples to a multichannel separation device having an equal number of separation channels; separating (102) the samples in parallel in said number of separation channels; supplying said channels to an array dispenser after separation; dispensing (103) said channels in parallel on to a target plate maintaining the separation of the multichannel separation device.

### FIELD OF THE INVENTION

The present invention relates to a method and a machine for biomolecule handling using an array dispenser. More particularly, the invention relates to a method and an machine in which one or two separation procedures are performed in parallel channels and the separated biomolecules are deposited on a two-dimensional target plate for analysis e.g. in a MALDI TOF MS device (Matrix Assisted Laser Desorption/Ionisation Time-of-Flight Mass Spectrometry).

### STATE OF THE ART

In the art many processes and procedures are known for analysing biomolecules, such as proteins, peptides, oligonucleotides, and polysaccharides using e.g. digestion of proteins, liquid chromatography and gel separation. Some of these procedures are most time consuming. On the other hand, when a sample is ready for MALDI TOF MS this step is relatively quick. Thus, there is a need for methods and machines in which time consuming steps are performed in parallel to produce samples on target plates for analysis with MALDI TOF MS.

The present invention solves these problems by providing a method and machine in which a multichannel array dispenser is arranged to receive several channels in which separations have been performed in a parallel format in at least one dimension in which the array dispenser is arranged to dispense those channels on a target plate in two dimensions for analysis with e.g. MALDI TOF MS.

### SUMMARY OF THE INVENTION

The invention is defined in the attached claims.

### BRIEF DESCRIPTION OF THE DRAWINGS

The invention will be described in detail below with reference to the accompanying drawings in which

FIG. 1 is a flowchart illustrating a general overview of a first embodiment of the method according to the invention,

FIG. 2 is a flowchart illustrating a general overview of a second embodiment of the method according to the invention,

FIG. 3 is a flowchart illustrating a general overview of a complementary process of the method according to the invention,

FIG. 4 is a block diagram of a first embodiment of the invention,

FIG. 5 is a block diagram of a second embodiment of the invention,

FIG. 6 is an embodiment of a third embodiment of the invention,

FIG. 7 is a detail view of packed capillary device for liquid chromatography,

FIG. 8 is a detail view of a packed plastic chip for liquid chromatography,

FIG. 9 is a cross-sectional view of a liquid chromatography plastic chip together with an array dispenser according to the invention,

FIG. 10 is a cross-sectional view of an array dispenser depositing samples on a target plate, and

FIG. 11 shows all example of proteins separated on a gel in one embodiment of a gel separation device according to the invention.

### DETAILED DESCRIPTION OF PREFERRED EMBODIMENTS

The purpose of the present invention is to provide a method and machine for handling, of biomolecules such as carbohydrates (polysaccharides), oligonucleotides and proteins and peptides in which time consuming procedures are performed in parallel while exploiting the quickness of analysis procedures such as MALDI TOF MS (Matrix Assisted Laser Desorption/Ionisation Time-of-Flight Mass Spectrometry). A key to this concept is using an array dispenser. The array dispenser is a multichannel dispenser receiving a number of channels and dispensing them simultaneously in a controlled fashion onto a two-dimensional target plate e.g. suitable for MALDI TOF MS. The general principles of the procedures used in the invention are well known per se and the procedures are only adapted to fit in with the concept of the invention. For a better understanding of the invention some procedures are described below.

Digestion

The digestion of proteins into peptides may optionally be performed at different stages in the method of the invention. Generally the protein mix is digested in a container by bringing the proteins in contact with enzymes. This may be performed in a separate container. A special case in the invention is to digest proteins on the target plate itself in which case the target plate is precoated with enzymes at the spots or wells where the protein mix is deposited by the array dispenser.

Isotope Labelling

Quantitative analysis is performed by making isotope reagent labelling of sample 1 and sample 2 where the two reagents differs in molecular mass by e.g. 6, 8, or 12 Daltons.

The protein samples can be derivatised either as; intact proteins, or as digested proteins, i.e. the corresponding peptide map, the enzymatic product. The reagent-protein/peptide binding is, but is not exclusively a covalent binding. The two successively derivatised samples are next mixed where the corresponding peptide pairs from the same proteins are present in these samples. In case of protein samples, a digestion step is undertaken for five hours, or overnight. By single, or multidimensional separations, the peptides present in sample 1 and 2 will elute as corresponding pairs with the same physio-chemical properties, except that it has a 6, 8, or 12 Daltons shift in mass difference.

For instance two protein samples from different sources may be labelled with isotopes having different masses. In the resulting mass spectrum two identical proteins present in both samples will show up as two peaks separated by the mass difference of the isotopes. On the other hand, a protein present in only one sample will show up as a single peak. The single peaks may be separated from a clinical study material since one is often interested in the difference between two samples, for instance when one sample is obtained from a sick person and another is obtained front a healthy person.

Fluorescence Labelling

Quantitative analysis is performed by making isotope reagent labelling of a sample where e.g. four reagents differs in fluorescence groups which will bind to different nucleotides. When illuminated the nucleotides will appear as different colours. The protein samples can be derivatised either as; intact proteins, or as digested proteins, i.e. the corresponding peptide map, the enzymatic product.

Chemical Degradation

Protein samples are handled by biochemical and chemical pre-treatment in order to make the three-dimensional structure of the protein unfold and accessible to enzymatic cleavage, resulting in a peptide composition corresponding to the protein. All of the wet-lab experimental parts, may be performed by robotics. The first interface occurs in-between the sample introduction and the handling machine of the invention.

Polysaccharide samples are treated with chemical agents in combination with elevated temperatures that makes the polysaccharide structure amenable to enzymatic reactions, whereby oligomers and/or monomers are formed as enzymatic products.

Enzymatic Cleavage

Enzymatic cleavage is made in order to cleave the protein from the carbohydrate moiety of the glycoprotein structure. Highly specific glycoenzymes are used whereby a selective cleavage is obtained by either N-linked saccharides or )-linked saccharides. Further, additional specific enzymes such as α, β, or other Amyloses and/or amyloglycosidases are used in order to sequence saccharoide polymer. These enzymatic reactions are performed most often at elevated temperatures and in combination with chemical agents.

On-Spot Enrichment

A large number of droplets may be deposited on a small spot on a target plate while allowing the carrier liquid of the droplets to evaporate between consecutive droplets. This results in that the biomolecule density of the analyte will increase the more droplets are deposited on the plate, a so-called on-spot enrichment.

On-Spot Enrichment with Diversity

The target plate may be prepared with different chemical agents, matrices and enzymes arranged on the spots in a predetermined pattern. An analyte discharged on such a plate will react differently on the different spots enabling diversity in the subsequent analysis.

On-Spot Hybridisation

The target plate may be prepared with different single strands of nucleic acid chains (RNA/DNA) which will bind to complementary single strands of nucleic acid chains (in a hybridisation reaction). This is exploited to achieve a very sensitive detection of specific (RNA/DNA). The RNA/DNA not bound to the target plate is washed away and the remaining RNA/DNA may be detected e.g. by fluorescence detection.

Liquid Chromatography (LC) Separation

In liquid chromatography biomolecules are separated by bringing a liquid containing the biomolecules to flow through a channel. The liquid is moved by pressure (pumping). The channel may be a quartz capillary or specially devised plastic chip in which the channels are packed with microbeads separating the sample according to size, electrostatic charge, hydrophobic/hydrophilic properties, immunoaffinity etc. The sample flowing out from the channel will have a varying composition of biomolecules according to the separation performed. Thus, samples collected at varying times will have different components of the analyte fraction.

Capillary electrophoresis (CE) Separation

In capillary electrophoresis biomolecules are separated by bringing a liquid containing the biomolecules to flow through a channel. The liquid is moved by applying a voltage along the length of the flow path. The channel is a quartz capillary in which the channels are packed with a polymer gel or microbeads separating the sample according to electrostatic charge. An open tubular design is also possible. The sample flowing out from the channel will have a varying composition of biomolecules according to the separation performed. Thus, samples collected at varying times will have different components of the analyte fraction.

Gel Separation

In gel separation biomolecules are separated by being forced to move through a gel with a pH-gradient over which an electric field is applied (one-dimensional separation). The biomolecules will be collected into bands that may be excised. Also molecular sieving may be used in combination with an electrostatic field (two-dimensional separation). In the invention it is contemplated to use a fixed punch for excising gel slices. As an alternative, bands may be selected automatically by a scanner for selecting intense bands or bands of particular interest. Generally, the polymeric biomacromolecule in each gel slice is digested into smaller fragments such as peptides and simultaneously extracted from the gel. Then the fragments are processed further and analysed.

It is also possible to electroelute the biomolecules from the gel without digesting them into peptides.

Immunoaffinity Separation

In immunoaffinity separation antigens are separated by being forced to move through a medium carrying antibodies having specific immunoaffinity to desired antigens. As the antigens passes through the medium the antigens are coupled to the respective antibodies forming immunocomplexes. The immunocomplexes are then released from the medium by elution. A pH gradient in the elution is used to achieve a separation of different immunocomplexes based on the varying pH dependence of the immunocomplex bindings. A second dimension separation is performed on the immunocomplexes, typically by means of liquid chromatography, based on electrostatic charge or hydrophobic affinity.

Each of the aforementioned techniques can be performed by; pressure driven or electrically driven devices or other suitable techniques.

Chromatographic separation where we will utilise mechanisms of

Chemical Binding

i/ size exclusion—in samples where fractionation is required based upon size.

ii/ hydrophobic interactions—utilisation of reversed phase separation mechanisms whereby peptides and proteins will be separated by its hydrophobicity.

iii/ polar interactions—silanol, and other types of polar functionalities readily interact with polar peptides/proteins and can be separated based upon polar chromatographic interactions.

Affinity Binding by:

i/ Chiral affinity—chiral small molecules may lend itself to be used as selective ligands for proteins/peptides to interact with whereby separations will be obtained.

ii/ Metal affinity—Chelation by metal ion interaction of amine, and or carboxy-hydroxy functional groups, as well as Nickel ion-Histidine peptide residues, iron-, Gallium-ions and phosphate functionalities on peptides binds strongly.

Biochemical Bindings:

iii/ Antibody binding—Traditional biochemical bindings antibody-antigen immunoaffinity bindings with both weak-medium-strong affinities with binding constants ranging in-between 10⁷-10⁹.

iv/ Receptor—ligand binding

v/ Biotin avidin—affinity reagents utilising either Avidin or Biotin bound to peptides and either Avidin or Biotin on a solid support will selectively isolate peptides from complex sample mixtures due to the high affinity between Avidin/Biotin.

v/ Additionally any other type of protein—protein bindings using capture biomolecules bound onto a solid support.

Array Dispensing

The array dispenser is a special feature of the present invention. The array dispenser is designed to dispense several channels at the same time on to a target plate. The array dispenser can be interfaced with a separation unit, such as a liquid chromatography, capillary electrophoresis unit or gel separation unit. Each received channel is separated as mentioned above in a time varying manner, such that a two-dimensional array of deposited samples are dispensed on the target plate. With a flow through design, a small part of the liquid is dispensed on the target plate, while the remaining larger part of the liquid may be collected on a microtitre plate where the sample is saved for possible further processing, typically a selective repeated analysis, or by a complementary functional assay.

MALDI TOF MS Analysis

Tile Matrix Assisted Laser Desorption/Ionisation Time-of-Flight Mass Spectrometry is a mass analysis technique that has been used for some time. The sample is dispersed in a large excess of matrix material, which will strongly absorb the incident laser light. The matrix also serves the isolate sample molecules in a chemical environment that enhances the probability of ionisation without fragmentation. Short pulses of laser light focused on the sample spot will cause the sample and matrix to volatilise. The analyte ions formed are then accelerated by an applied high voltage, separated according to mass in a field-free flight tube and detected as an electrical signal. More pulses gives a higher signal to noise ratio in the produced mass spectrum. Even if the sample is consumed eventually, it is a feature of MALDI TOF MS that the same sample may be subjected to the analysis in several repeated steps, in which the first steps are more coarse and the subsequent steps may be used to obtain more information, if the first steps showed there was something of interest.

Fluorescence Analysis

Fluorescence scanners are known in the art. The scanner emits laser light exciting the fluorescent label or dye. The reflected light is collected by an optical system. The differently labelled analytes will appear as different colours.

The table below shows some possible combinations of procedures and analytes.

| Procedure\ | | | | |
|---|---|---|---|---|
| Analyte | Proteins | Peptides | DNA/RNA | Polysaccharides |
| Digestion | Yes (to | No | No/Yes | Yes |
| | peptides) | | | |
| Isotope labelling | Yes | Yes | No | No |
| Fluorescence | Yes | Yes | Yes | Yes |
| labelling | | | | |
| Chemical | Yes | No | No | Yes |
| degradation | | | | |
| Liquid | Yes | Yes | — | — |
| chromatography, | | | | |
| electrostatic | | | | |
| Liquid | Yes | Yes | No | No |
| chromatography, | | | | |
| hydrophobic | | | | |
| Liquid | Yes | Yes | Yes/No | No |
| chromatography, | | | | |
| immunoaffinity | | | | |
| Capillary | Yes | Yes | Yes | Yes |
| electrophoresis | | | | |
| Hybridisation | No | No | Yes | No |
| (complementary | | | | |
| binding) | | | | |
| Gel-based | Yes | Yes | Yes | No |
| separation, | | | | |
| electrostatic | | | | |
| Gel-based | Yes | Yes | No | No |
| separation, pH | | | | |
| gradient | | | | |
| Elution from gel | Yes | Yes | — | — |
| Elution and | Yes | No | No | No |
| digestion from gel | | | | |
| Target plate | Yes | Yes | Yes | Yes |
| enrichment | | | | |
| Target plate | Yes | No | No | No |
| digestion | | | | |
| Target plate | No | No | Yes (for | — |
| hybridisation | | | complemen- | |
| | | | tary binding) | |
| MALDI | Yes | Yes | Yes | Yes |
| Fluorescence read | Yes | Yes | Yes | Yes |
| out | | | | |

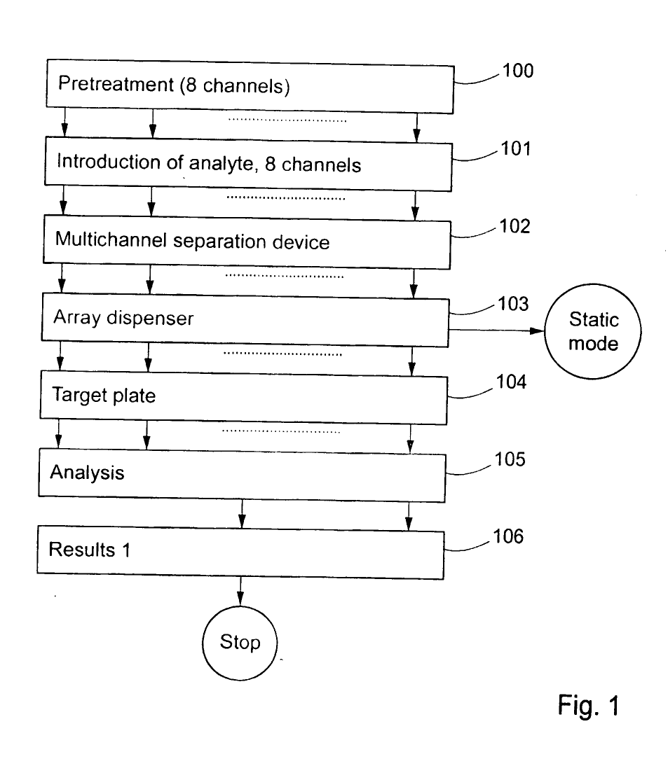

FIG. 1 shows a general overview of the method according to a first embodiment of the invention. Before the process starts, the biomolecule samples may need to be subjected to pre-treatment, such as chemical degradation, enzymatic cleavage, digestion, isotope labelling or fluorescence labelling, in step 100, in dependence of the starting material and wanted analysis. The process starts in step 101 with the introduction of a number of biomolecule samples into the machine. The number of samples suitably corresponds to the number of channels through the array dispenser, e.g. an equal number or an even multiple thereof. The sample mixes are brought through a first dimension multichannel separation device in separate channels in step 102.

The separate channels are dispensed by the array dispenser in step 103 on to a two-dimensional target plate which is moved stepwise in front of the array dispenser so that each row of the target plate will contain all the separate channels and the next row of the target plate will contain the same channels but samples dispensed at a later time window. Thus, one dimension of the target plate is the different channels and the other dimension of the target plate is the time varying composition of the samples (intrachannel separation) according to the liquid chromatography performed on each of the channels in the step before the array dispenser.

On the target plate enrichment is achieved and possibly other processes such as digestion in step 104.
The whole target plate is prepared in this fashion and then subjected to analysis (e.g. using MALDI TOF MS) in the next step 105 providing the results (1) in step 106.

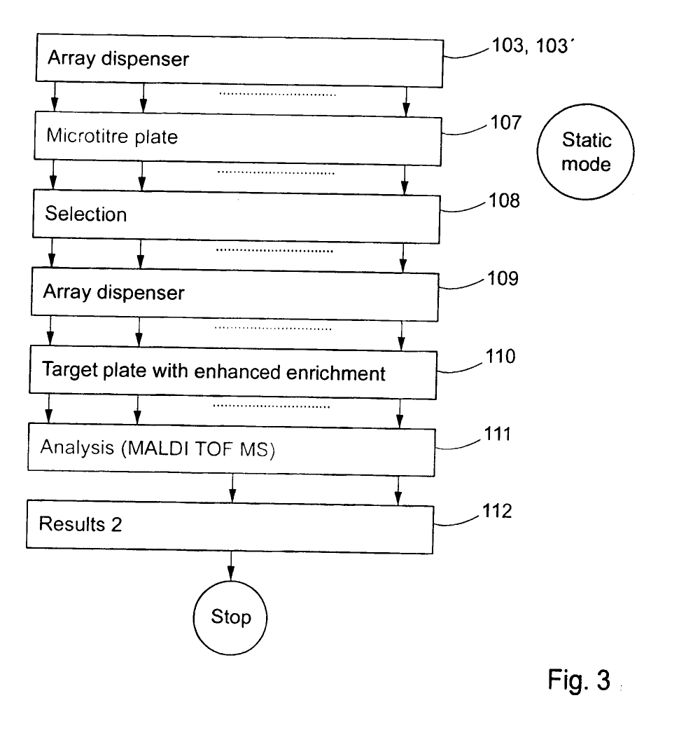

While a small part of the sample, e.g. 1/20, is deposited on the target plate, the remaining part, 19/20, may be saved on a microtitre plate in a step 107, FIG. 3. There is a one to one correspondence between the positions on the target plate and the positions on the microtitre plate.

After the first coarse results are provided by the analysis in step 106, selected sample positions on the target plate may be subjected to a new analysis as is outlined above and illustrated in FIG. 3.

The first coarse results 1 (shotgun screening process) provided by the analysis in step 106, may for instance yield a peptide, which unambiguously annotates (identifies) a specific protein. When the protein is known it is often desired to investigate the existence of other peptides which are not visible in the noise of the MALDI spectrum in the first coarse analysis. Since the properties of these peptides are known, it is possible to select in a step 108 the correct corresponding sample positions on the microtitre plate produced simultaneously (in step 107). The samples in these positions are deposited on a new target plate in a step 109, preferably in a larger amount, such that enhanced on-spot enrichment is achieved in step 110. Then, the new target plate is subjected to a new analysis in a step 111, in which the noise is lowered, which allows for investigation of the peptides occurring in lower concentrations in the original sample. The results 2 obtained in step 112 (improved sequencing process) gives a more detailed knowledge about the studied protein.

If the start mixes in step 101 are large biomolecules (proteins), a digestion is performed on the target plate in step 104. If the start mixes are smaller biomolecules (e.g. peptides already digested in the pre-treatment step 100) this step is omitted.

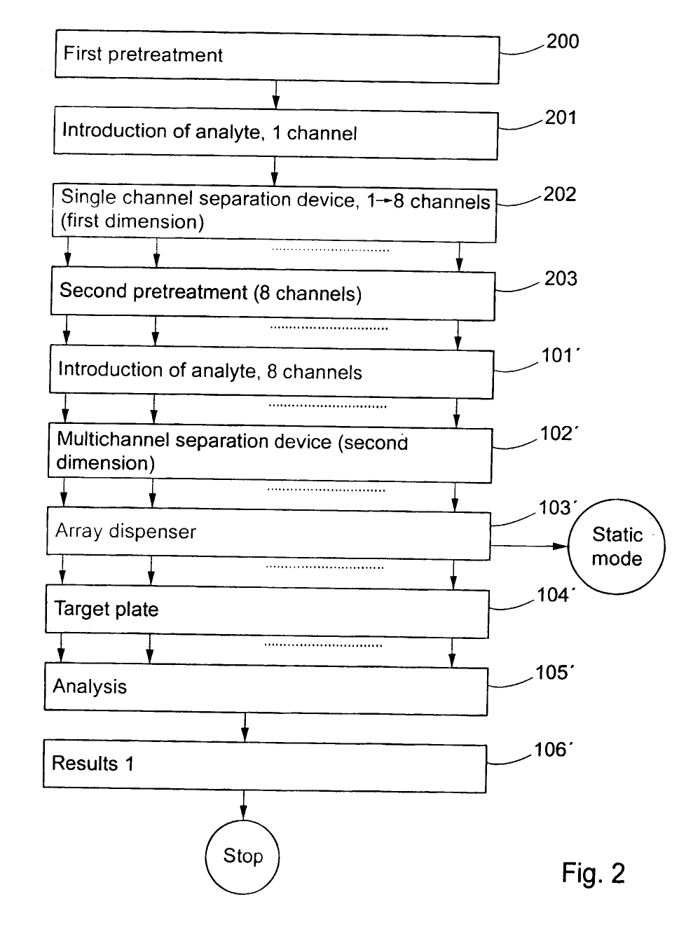

FIG. 2 shows a further embodiment of the invention in which two separations in different dimensions are performed. To obtain the number of samples in step 101 of the first embodiment, it is possible to perform a first single channel separation in another dimension than the separation dimension of step 102. Before the process starts, the biomolecule samples may need to be subjected to a first pre-treatment, such as digestion or labelling, in step 200. The process may start with one biomolecule mix in step 201. This sample mix is then subjected to a first dimension separation in step 202. If liquid chromatography is emloyed, this first dimension is typically based on electrostatic interaction and the second dimension (step 102′ below) is based on hydrophobic interaction. The first dimension separation produces a number of separated fractions of the original biomolecule mix. Before the process continues, the biomolecule samples may need to be subjected to a second pre-treatment, such as digestion or labelling, in step 203.

The separated fractions are then run through step 101′ through 106′, which may be identical with steps 101 through 106 discussed above. Also the static mode sample deposition in steps 107 through 112 may be performed.

If the original sample mix in step 201 is a large biomolecule mix a digestion must be performed before the analysis. This digestion may be performed optionally in the separate pre-treatment step 203 or on the target plate in step 104′.

As an alternative, the first dimension separation may be a gel separation. The process starts with a biomolecule sample mix in step 201. The first dimension gel separation is performed in step 202. This step includes the separation in the gel, the cutting of the gel into slices by means of the fixed punch or a selective cutting device. The cut out gel slices are then digested or eluted in step 203 to produce a number of biomolecule samples having smaller biomolecules to be supplied to the second dimension liquid chromatography in step 102′.

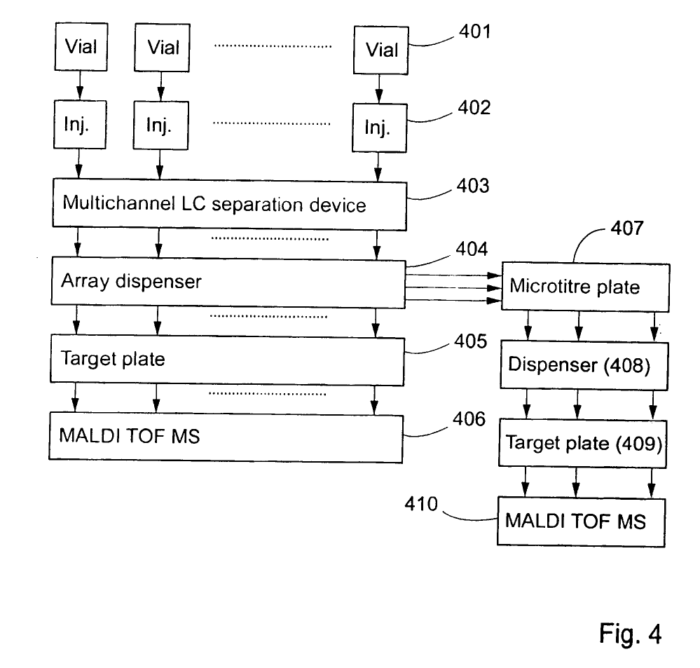

A first embodiment of the machine according to the invention is shown schematically in FIG. 4. This machine corresponds to the method steps 101-112. The machine comprises a multichannel LC separation device 403 receiving samples contained in a number of vials 401 and injected by a number of injectors 402 into the multichannel LC separation device. The multichannel LC separation device 403 is connected or dockable to an array dispenser 404 which in turn dispenses the number of channels on to a target plate 405. The target plate 405 is then brought to ac MALDI TOF MS device 406. Simultaneously, the array dispenser 404 dispenses the same number of channels on to a microtitre plate 407. A dispenser 408 may be controlled to dispense samples from selected positions on the microtitre plate 407 on to another target plate 409 that is then brought to a MALDI TOF MS device 410 (which may be identical with the MALDI TOF MS device 406). The separate device units 403-410 are described in detail below.

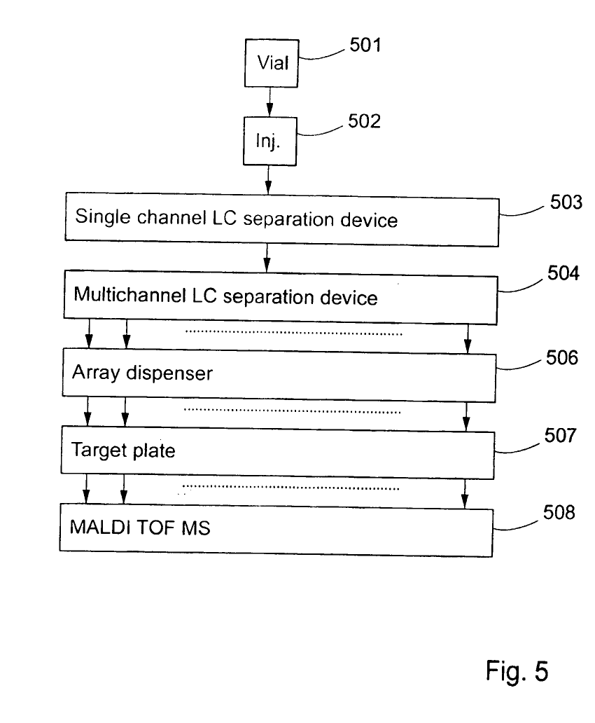

A second embodiment of the machine according to the invention is described in FIG. 5. This machine corresponds to the method steps 201-203 and 101′-106′. A single channel LC separation device 503 receives a sample contained in a vial 501 and injected by an injector 502 and separates the original mix in the vial 501 into a number of channels as symbolised by the multiple arrows. The single channel may be a quartz capillary or a plastic chip device. The multichannel LC separation device 505, the array dispenser 506, the target plate 507 and the MALDI TOF MS device 508 may be identical with the corresponding units 403-406 of the first embodiment.

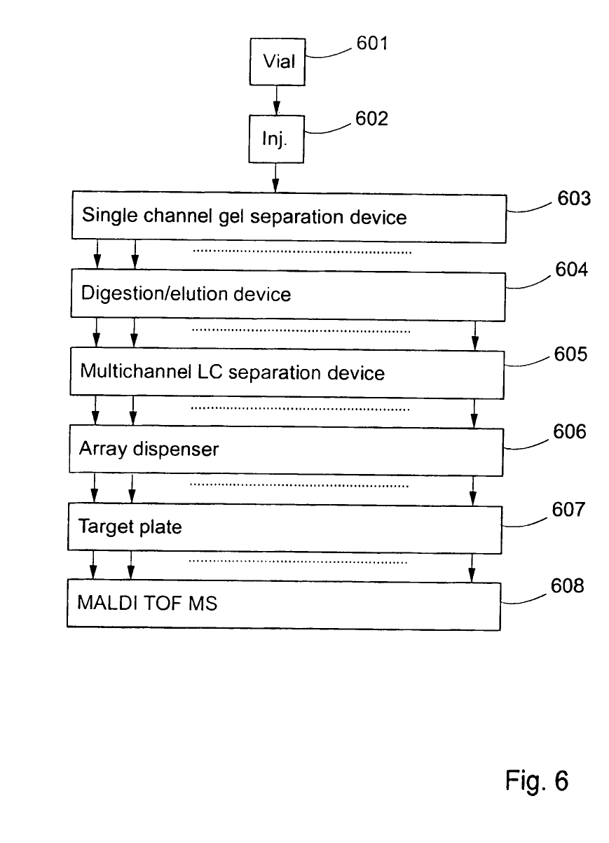

A third embodiment of the invention is shown in FIG. 6. This machine also corresponds to the method steps 201-203 and 101′-106′. A single channel gel separation device 603 receives a sample contained in a vial 601 and injected by an injector 602. The sample is separated into bands in the gel. A number of bands are cut out and supplied to a digestion/elution device 604. The digestion/elution results in separation of the original mix in the vial 601 into a number of channels supplied to the multichannel LC separation device 605 as symbolised by the multiple arrows. The multichannel LC separation device 605, the array dispenser 606, the target plate 607 and the MALDI TOF MS device 608 may be identical with the corresponding units 403-406 of the first embodiment.

Many more embodiments of the invention are possible. A non-exclusive list of function modes or machines is set forth below.

### EXAMPLE OF FUNCTION MODES

### Example 1a (See FIG. 1)

In solution digestion, 1 dim LC separation
Starting material: proteins, 8 parallel vials;
Digestion to peptides, 8 parallel vials; (step 100)
One dimensional liquid chromatography separation, 8 parallel channels; (step 102)
Array dispensing, 8 parallel channels×12 rows; (step 103)
Target plate enrichment; (step 104)
MALDI TOF MS; (step 105, 106)

### Example 1b (See FIG. 1)

In solution digestion With isotope labelling, 1 dim LC separation
Starting material: proteins; sample A and sample B (×8)
Digestion into peptides and isotope labelling of sample A and sample B with different isotopes (×8) (step 100)
Mixing of sample A and sample B (×8), 8 parallel vials; (step 100)
One dimensional liquid chromatography separation, 8 parallel channels; (step 102)
Array dispensing, 8 parallel channels×12 rows; (step 103)
Target plate enrichment; (step 104)
MALDI TOF MS (with sample A and sample B separated) ; (step 105, 106)

### Example 2a (See FIG. 1)

On target plate digestion, 1 dim LC separation
Starting material: proteins, 8 parallel vials
One dimensional liquid chromatography separation, 8 parallel channels; (step 102)
Array dispensing, 8 parallel channels×12 rows; (step 103)
Target plate enrichment and digestion to peptides; (step 104)
MALDI TOF MS; (step 105, 106)

### Example 2b (See FIG. 1)

On target plate digestion, isotope labelling, 1 dim LC separation
Starting material: proteins; sample A and sample B (×8)
Isotope labelling of sample A and sample B with different isotopes (×8); (step 100)
Mixing of sample A and sample B (×8), 8 parallel vials; (step 100)
One dimensional liquid chromatography separation, 8 parallel channels; (step 102)
Array dispensing, 8 parallel channels×12 rows; (step 103)
Target plate enrichment and digestion to peptides; (step 104)
MALDI TOF MS (with sample A and sample B separated); (step 105, 106)

### Example 3a (See FIG. 1)

1 dim Gel Based separation, digestion and elution from gel
Starting material: proteins, 1 vial
One dimensional gel-based separation; (step 102)
Excision of 8 gel slices; (step 102)
Elution and digestion of peptides from the gel slices; (step 102)
Array dispensing, 8 parallel channels×12 rows; (step 103)
Target plate enrichment; (step 104)
MALDI TOF MS; (step 105, 106)

### Example 3b (See FIG. 1)

On target plate digestion, 1 dim Gel Based separation, elution from gel
Starting material: proteins, 1 vial
One dimensional gel-based separation; (step 102)
Excision of 8 gel slices; (step 102)
Elution of proteins from the gel slices; (step 102)
Array dispensing, 8 parallel channels×12 rows; (step 103)
Target plate enrichment and digestion; (step 104)
MALDI TOF MS; (step 105, 106)

### Example 4a (See FIG. 2)

In solution digestion, 2 dim LC separation
Starting material: proteins, 1 vial
Digestion to peptides, 1 vial; (step 200)
A first one dimensional liquid chromatography separation; (step 202)
Peptides, separated to 8 vials; (step 202)
A second one dimensional liquid chromatography separation, 8 parallel channels; (step 102′)
Array dispensing, 8 parallel channels×12 rows; (step 103′)
Target plate enrichment; (step 104′)
MALDI TOF MS; (step 105′, 106′)

### Example 4b (See FIG. 2)

In solution digestion with isotope labelling, 2 dim LC separation
Starting material: proteins, sample A and sample B
A first one dimensional liquid chromatography separation, one each for sample A and sample B; (step 202)
Proteins, separated into 8×2 vials, 8 lots each for sample A and sample B; (step 202)
Digestion into peptides and isotope labelling of sample A and sample B with different isotopes (2×8); (step 203)
Mixing of sample A and sample B, each separated lot of sample A mixed with a corresponding lot of sample B, 8 parallel vials; (step 203)
A second one dimensional liquid chromatography separation, 8 parallel channels; (step 102′)
Array dispensing, 8 parallel channels×12 rows; (step 103′)
Target plate enrichment; (step) 104′)
MALDI TOF MS (with sample A and sample B separated); (step 105′, 106′)

### Example 4c (See FIG. 2)

On target plate digestion, 1 dim immunoaffinity LC separation, 1 dim LC separation
Starting material: antigens
A first one dimensional liquid chromatography separation with antibodies having immunoaffinity to specific antigens; (step 202)
Immunocomplexes, separated into 8 vials; (step 202)
A second one dimensional liquid chromatography separation, 8 parallel channels; (step 102′)
Array dispensing, 8 parallel channels×12 rows; (step 103′)
Target plate enrichment and digestion; (step 104′)
MALDI TOF MS; (step 105′, 106′)

### Example 5 (See FIGS. 2 and 3)

2 dim Gel Based and LC separation, elution from gel, screening and static mode with enhanced enrichment
Starting material: proteins, 1 vial
A first one dimensional gel-based separation; (step 202)
Excision of 8 gel slices; (step 202)
Elution and digestion of peptides from the 8 gel slices; (step 203)
A second one dimensional liquid chromatography separation, 8 parallel channels; (step 102′)
Array dispensing, 8 parallel channels×12 rows on first target plate and simultaneous saving on microtitre plate, 8 parallel channels×12 rows; (step 103′)
Target plate enrichment; (step 104′)
MALDI TOF MS for screening; (step 105′, 106′)
Selection of analyte on microtitre plate for static mode analysis based on the screening; (step 108)
Dispensing on second target plate for static mode; (step 109)
Enhanced target plate enrichment; (step 110)
MALDI TOF MS; (step 111)

### Example 6a (See FIG. 1)

1 dim CE separation, fluorescence detection
Starting material: Oligonuclcotides (DNA/RNA), 8 parallel vials
Fluorescence labelling; (step 100)
One dimensional capillary electrophoresis separation, 8 parallel channels; (step 102)
Array dispensing, 8 parallel channels×12 rows; (step 103)
Target plate enrichment with hybridisation and binding to complementary DNA/RNA; (step 104)
Fluorescence read out; (step 105, 106)

### Example 6b (See FIG. 1)

In solution digestion, 1 dim CE separation, MALDI
Starting material: nucleotides (DNA/RNA), 8 parallel vials
Digestion and derivatisation to oligonucleotides (DNA/RNA fragments), 8 parallel vials; (step 100)
One dimensional capillary electrophoresis separation, 8 parallel channels; (step 102)
Array dispensing, 8 parallel channels×12 rows; (step 103)
Target plate enrichment; (step 104)
MALDI TOF MS; (step 105, 106)

### Example 7a (See FIG. 1)

1 dim CE separation
Starting material: polysaccharides, 1 vial
Digestion of the polysaccharides into oligosaccharides/monosaccharides; (step 100)
A one dimensional capillary electrophoresis separation, 8 parallel channels; (step 102)
Array dispensing, 8 parallel channels×12 rows on target plate; (step 103)
Target plate enrichment; (step 104)
MALDI TOF MS; (step 105, 106)

### Example 7b (See FIG. 1)

1 dim LC separation
Starting material: polysaccharides, 1 vial
Digestion of the polysaccharides into oligosaccharides/monosaccharides; (step 100)
A one dimensional liquid chromatography separation, 8 parallel channels; (step 102)
Array dispensing, 8 parallel channels×12 rows on target plate; (step 103)
Target plate enrichment with diversity; (step 104)
MALDI TOF MS; (step 105, 106)

In FIG. 7 an embodiment of a liquid chromatography quartz capillary device is shown. The device comprises a number of capillaries having a length of approximately 10-30 cm and an internal diameter in the range of 50 to 200 μm. They may be packed with beads or a gel. Electrostatic fields or hydrophobic gradients are applied over the channels. The beads are treated so that the biomolecules are separated to a varying degree when travelling through the capillaries in dependence of the size, affinity etc. of the biomolecules. The capillaries are connected to an array dispenser 6 or a digestion device e.g. by means of ferrules 18.

The quartz capillary device may form part of multichannel separation device used in the present invention. The device is provided with suitable connections for receiving samples from injectors and supplying the separated samples to a subsequent device, such as a digestion device or a dispenser. A single channel separation device of course only needs one such channel.

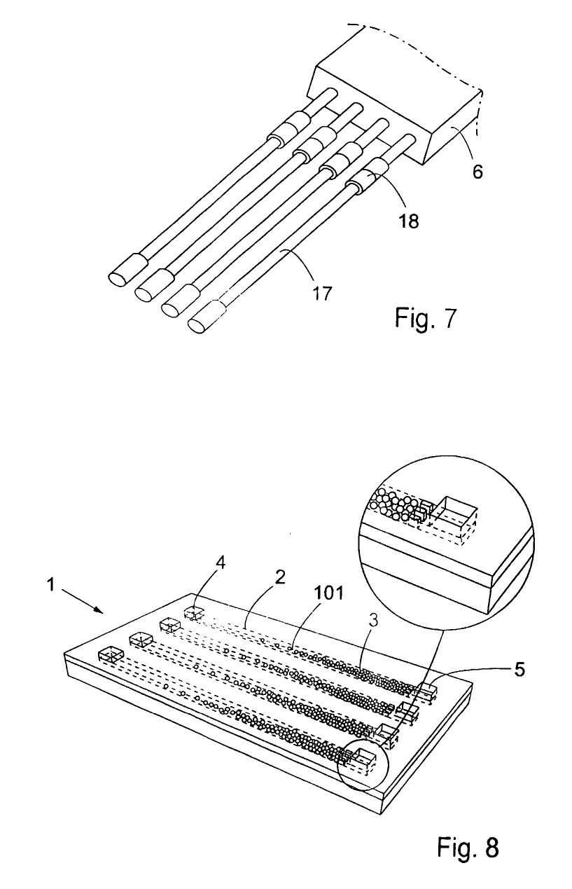

In FIG. 8 another embodiment of a multichannel separation device is shown, here in the form of a plastic chip 1 packed with beads. A number of channels 2 are formed in the chip, each channel containing a porous bed 3 of microscopic beads. The device is provided with suitable connections for receiving samples from injectors at an inlet 4 and supplying the separated samples at an outlet 5 to a subsequent device, such as a digestion device or a dispenser. A single channel separation device of course only needs one such channel. The function of the plastic chip is in principle identical with the quartz capillary device.

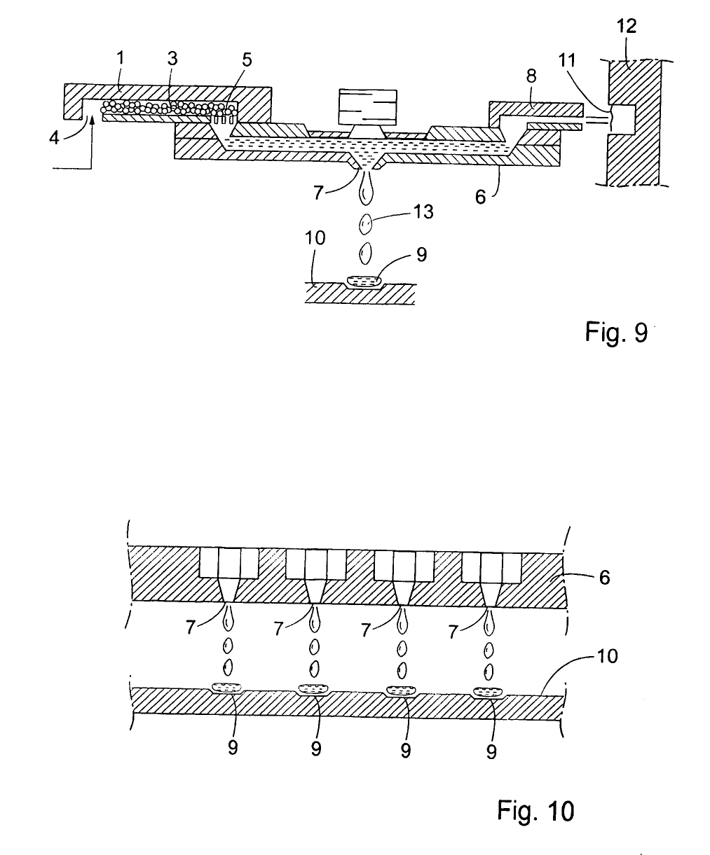

FIG. 9 shows a plastic chip device I connected to an array dispenser 6. Each channel of the plastic chip I is associated with one nozzle 7 of the array dispenser 6 and one large outlet 8. Each nozzle 7 is directed to a spot 9 or well on a target plate 10 shown at the bottom. Each large outlet 8 is directed to a well 11 on a microtitre target plate 12 shown to the right. The dispenser 6 shoots a number of droplets 13 onto the target plate 10 into the same position while the sample mix is supplied continuously through the dispenser. The larger part of the sample mix flowing past the droplet nozzle 7 is dispensed from the large outlet 8 on to the microtitre plate 12. When the required number of drops has been shot the target plate 10 is moved relative to the array dispenser 6 so that a new row of positions is filled on the target plate 10. The dispensing from the large outlets 8 is controlled in a synchronised manner such that a one-to-one correspondence is achieved between the positions on the target plate 10 and the microtitre plate 12.

The array dispenser 6 may be designed without the large outlets 8, in case no flow through is needed.

In a preferred embodiment the dispenser comprises two plates, a base plate and a lid bonded together. The dispenser nozzle array comprises a chamber in the base plate, having at least two inlets and at least two dispenser nozzles, and a membrane entity in the lid comprising at least one flexible membrane, and at least one push bar connected via a beam to a single piezoelectric element providing actuation force for dispensing droplets of liquid through said at least two nozzles simultaneously. The number of dispenser nozzles is suitably adapted to the number of positions on the target plate, preferably an equal number or an even multiple thereof.

FIG. 10 shows a detail of the array dispenser 6 and the target plate 10 in cross-section along a row of nozzles of the array dispenser 6.

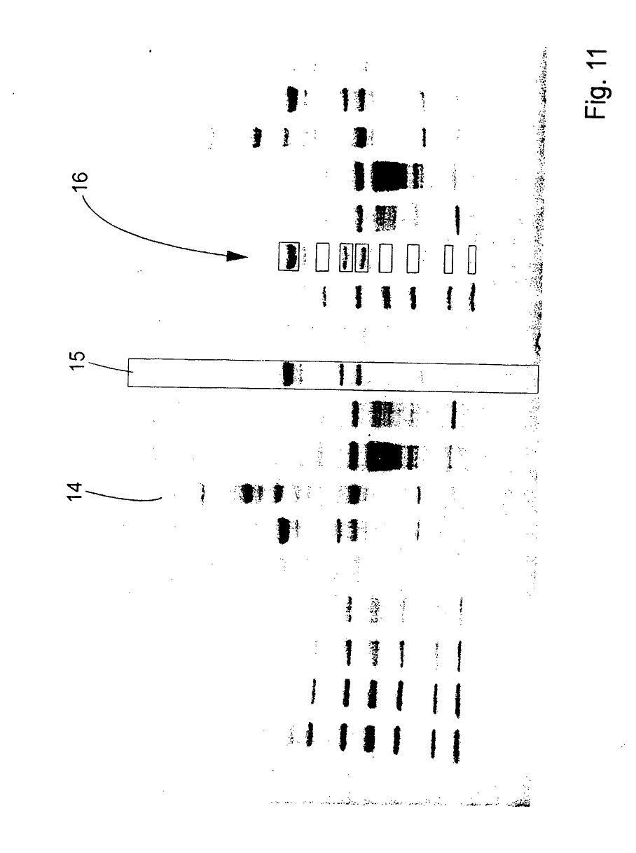

FIG. 11 shows an example of proteins separated on a gel in one embodiment of a gel separation device according to the invention. As is known in the art, a one-dimensional gel separation produces a gel sheet with a number of bands 14 formed by collected proteins. A two-dimensional gel separation would produce a gel sheet with a number of spots formed by collected proteins. The same proteins are always found in the same band at more or less the same position. When the gel separation sheet is done the sheet is cut into slices 15 for further processing of the trapped proteins. In one embodiment, the sheet is cut by means of a punch device in which the positions of the cut out slices are fixed in a precalculated pattern 16. The cutting is performed automatically by means of a robot supplying the cut out slices to a subsequent digestion or elution device. Different fixed punches may be provided for different purpose.

In another embodiment, the sheet is scanned and bands are selected to be cut out by a cutting means. This may also be performed automatically by a robot.

1. A method of sample handling comprising the following steps:
supplying a number of samples to a multichannel separation device having an equal number of separation channels;
separating the samples in parallel in said number of separation channels; supplying said channels to an array dispenser after separation;
dispensing said channels in parallel on to a target plate maintaining the separation of the multichannel separation device.

2. A method of sample handling according to claim 1, wherein said separation in the multichannel separation device comprises liquid chromatography, gel-based chromatography or capillary electrophoresis.

3. A method of sample handling according to claim 1, wherein said number of samples are provided by the steps of:
supplying a first sample to a single channel separation device having a separation channel separating the sample in at least one dimension into said number of samples.

4. A method of sample handling according to claim 3, wherein the separation in the single channel separation device and the separation in the multichannel separation device both comprise liquid chromatography but performed in different dimensions.

5. A method of sample handling according to claim 4, wherein the separation performed by liquid chromatography in the single channel separation device is electrophoretic and/or pressure driven, and the liquid chromatography in the multichannel separation device is hydrophobic, or vice versa.

6. A method of sample handling according to claim 3, wherein the separation in the single channel separation device comprises gel separation, and the separation in the multichannel separation device comprises liquid chromatography, said separations being performed in different dimensions.

7. A method of sample handling according to claim 6, wherein the gel separation comprises cutting the gel into samples by means of a punch device having a fixed punch pattern.

8. A method of sample handling according to claim 6, wherein the gel separation comprises cutting the gel into samples by means of a selective cutting device.

9. A method of sample handling according to claim 6, wherein the gel separation in the single channel separation device is electrophoretic and pressure driven, and/or the liquid chromatography in the multichannel separation device is hydrophobic.

10. A method of sample handling according to claim 1, wherein the samples are peptide mixes.

11. A method of sample handling according to claim 1, wherein the samples are protein mixes, and the separated proteins are digested on the target plate.

12. A method of sample handling according to claim 3, wherein the first sample is a peptide mix.

13. A method of sample handling according to claim 3, wherein the first sample is a protein mix and the separated proteins are digested on the target plate.

14. A method of sample handling according to claim 3, wherein the first sample is a protein mix and the separated proteins are digested in a separate step before supplying the number of samples to the multichannel separation device.

15. A method of sample handling according to claim 6, wherein the first sample is a protein mix and the proteins separated in the gel separation are electroeluted from the cut gel and the separated proteins are digested on the target plate.

16. A method of sample handling according to claim 11, wherein the target plate is precoated with enzymes.

17. A method of sample handling according to claim 6, wherein the first sample is a protein mix and the proteins separated in the gel separation are digested in a separate step and extracted from the gel before supplying the number of samples to the multichannel separation device.

18. A method of sample handling according to claim 1, wherein the first sample is an oligonucleotide mix, the multichannel separation comprises capillary electrophoresis, and the separated oligonucleotide mix is subjected to a hybridization step on the target plate.

19. A method of sample handling according to claim 1, wherein the first sample is a DNA/RNA mix which is digested and derivatised to oligonucleotides, and the multichannel separation comprises capillary electrophoresis.

20. A method of sample handling according to claim 19, wherein the target plate is prepared with different single strands of nucleic acid chains.

21. A method of sample handling according to claim 1, wherein the first sample is a polysaccharide mix which is digested to oligosaccharides/monosaccharides, and the multichannel separation comprises capillary electrophoresis.

22. A method of sample handling according to claim 1, wherein the first sample is a polysaccharide mix which is digested to oligosaccharides/monosaccharides, the multichannel separation comprises liquid chromatography, and the separated oligonucleotide mix is subjected to enrichment with diversity on the target plate.

23. A method of sample handling according to claim 3, wherein the first sample is an antigen mix, the single channel separation comprises liquid chromatography based on immunoaffinity interaction, the multichannel separation comprises liquid chromatography, and the separated antigen mix is subjected to a digestion step on the target plate.

24. A method of sample handling according to claim 1 wherein the target plate is prepared with different chemical agents, matrices and/or enzymes arranged on the spots in a predetermined pattern.

25. A method of sample handling according to claim 1, wherein the target plate is subjected to an analysis step comprising MALDI TOF MS (Matrix Assisted Laser Desorption/Ionisation Time-of-Flight Mass Spectrometry).

26. A method of sample handling according to claim 1, wherein the target plate is subjected to an analysis step comprising fluorescence detection.

27. A method of sample handling according to claim 25 wherein said channels also are dispensed in parallel on to a microtitre plate maintaining the same intrachannel separation of the multichannel separation device, and a second analysis step is performed after said first analysis using samples dispensed on to the microtitre plate.

28. A machine for sample handling comprising:
a multichannel separation device for receiving a number of samples and having an equal number of separation channels for separating the samples in parallel;
an array dispenser for dispensing said channels in parallel after separation on to a target plate maintaining the separation of the multichannel separation device;
said target plate being suitable for subjecting to an analysis device.

29. A machine for sample handling according to claim 28, wherein the multichannel separation device comprises a liquid chromatography, a gel-based chromatography or a capillary electrophoresis unit.

30. A machine for sample handling according to claim 29, wherein the multichannel separation device comprises a quartz capillary unit.

31. A machine for sample handling according to claim 29, wherein the multichannel separation device comprises a plastic chip.

32. A machine for sample handling according to claim 28, wherein the samples are protein mixes, and the target plate is precoated with enzymes for digesting the separated proteins on the target plate.

33. A machine for sample handling according to claim 28, further including:
a single channel separation device for receiving a first sample and having a separation channel separating the sample in at least one dimension into said number of samples.

34. A machine for sample handling according to claim 33, wherein the single channel separation device and the multichannel separation device both comprise liquid chromatography units, but adapted to perform separations in different dimensions.

35. A machine for sample handling according to claim 34, wherein the single channel separation device is adapted to perform electrostatic liquid chromatography and the multichannel separation device is adapted to perform hydrophobic liquid chromatography, or vice versa.

36. A machine for sample handling according to claim 34 wherein the liquid chromatography units comprise quartz capillary units.

37. A machine for sample handling according to claim 34 wherein the liquid chromatography units comprise plastic chips.

38. A machine for sample handling according to claim 34 wherein the single channel separation device comprises a quartz capillary unit and the multichannel separation device comprises a plastic chip, or vice versa.

39. A machine for sample handling according to claim 33, wherein the first sample is a protein mix and the target plate is precoated with enzymes for digesting the separated proteins on the target plate.

40. A machine for sample handling according to claim 33, wherein the first sample is a protein mix and the machine further includes a digestion unit for digesting the separated proteins in a separate step before supplying the number of samples to the multichannel separation device.

41. A machine for sample handling according to claim 33, wherein the single channel separation device comprises a gel separation unit, and the multichannel separation device comprises a liquid chromatography unit, said gel separation unit and liquid chromatography unit being adapted to perform separations in different dimensions.

42. A machine for sample handling according to claim 41, wherein the gel separation unit comprises a fixed punch device having a predetermined punch pattern for cutting the gel into samples.

43. A machine for sample handling according to claim 41, wherein the gel separation unit comprises a selective cutting device for cutting the gel into samples.

44. A machine for sample handling according to claim 41, wherein the gel separation unit in the single channel separation device is adapted to perform electrostatic separation and the liquid chromatography unit in the multichannel separation device is adapted to perform hydrophobic separation.

45. A machine for sample handling according to claim 41, wherein the first sample is a protein mix and the machine further includes an electro-elution unit for electroeluting the proteins separated in the gel separation from the cut gel and the target plate is precoated with enzymes for digesting the separated proteins on the target plate.

46. A machine or sample handling according to claim 41, wherein the first sample is a protein mix and the machine further includes a digestion unit for digesting the separated proteins in a separate step before supplying the number of samples to the multichannel separation device.

47. A method of sample handling according to claim 28, wherein the target plate is prepared with different chemical agents, matrices and/or enzymes arranged on the spots in a predetermined pattern.

48. A method of sample handling according to claim 28, wherein the target plate is prepared with different single strands of nucleic acid chains.

49. A machine for sample handling according to claim 28, wherein the machine further includes a MALDI TOF MS UNIT (Matrix Assisted Laser Desorption/Ionisation Time-of-Flight Mass Spectrometry) for the analysis step.

50. A machine for sample handling according to claim 28, wherein the machine further includes a fluorescence detection unit for the analysis step.

51. A machine for sample handling according to claim 49 wherein the array dispenser further is adapted to dispense said channels in parallel after separation on to a microtitre plate maintaining the same intrachannel separation of the multichannel separation device, and the machine further includes a dispenser controlled to dispense samples from selected positions on the microtitre plate on to another target plate suitable for subjecting to analysis.
